(19) United States
(12) Patent Application Publication
(10) Pub. No.: US 2016/0230727 A1
(43) Pub. Date: Aug. 11, 2016

(54) FUEL INJECTION PUMP

(71) Applicant: YANMAR CO., LTD., Osaka-shi, Osaka (JP)

(72) Inventors: Masaki NANKOU, Osaka-shi, Osaka (JP); Isao TAKAGISHI, Osaka-shi, Osaka (JP); Yuji SHIBA, Osaka-shi, Osaka (JP); Kouichi KONDOU, Osaka-shi, Osaka (JP); Ryota IWANO, Osaka-shi, Osaka (JP)

(21) Appl. No.: 15/024,987

(22) PCT Filed: Jul. 25, 2014
(86) PCT No.: PCT/JP2014/069646

§ 371 Date: Mar. 25, 2016

(30) Foreign Application Priority Data
Sep. 30, 2013 (JP) 2013-204725
Sep. 30, 2013 (JP) 2013-204726

(51) Int. Cl. F02M 59/24; F02M 61/18; F02M 55/04; F02M 59/10; F02M 59/46

(52) U.S. Cl. CPC F02M 59/243; F02M 59/10; F02M 59/462; F02M 55/04; F02M 61/18

(57) ABSTRACT

A fuel injection pump delivers, at high pressure, a fuel to be injected into a combustion chamber of a diesel engine and includes a delivery valve disposed in the middle of a path for pressure-feeding the fuel from a plunger to a fuel injection nozzle. A damping valve is disposed on the downstream side of the delivery valve. The damping valve includes a valve element which has an orifice formed on an axial part thereof and is biased downward (toward the upstream side) by a damping valve spring and a receiving element which has a passage hole formed on an axial part thereof and abuts against the valve element. A recess which communicates with the passage hole is formed on a face of the valve element, the face facing the receiving element.

### TECHNICAL FIELD

The present invention relates to techniques of a fuel injection pump.

### BACKGROUND ART

Fuel injection pumps are known as pumps that deliver, at high pressure, a fuel to be injected into a combustion chamber of a diesel engine. The fuel injection pump delivers a fuel that is pressure-fed by allowing a plunger to vertically slide inside a plunger barrel to a plurality of delivery valves and pressure-feeds the fuel to a fuel injection nozzle from each of the delivery valves (Patent Document 1, for example).

In a diesel engine, it is necessary to significantly reduce “soot (hereinbelow, referred to as Sd)” due to restriction. In a diesel engine, it is effective to delay a fuel injection timing to significantly reduce Sd. On the other hand, in a diesel engine, the delay in the fuel injection timing significantly deteriorates a white smoke disappearance time (a time from engine start to the disappearance of white smoke).

On the other hand, the generation of white smoke also has a correlation with an initial injection rate. In a diesel engine, when the initial injection rate is high, a combustion temperature is reduced. The reduction in the combustion temperature results in imperfect combustion. The imperfect combustion results in the generation of white smoke. That is, the generation of white smoke can be reduced by reducing the initial injection rate.

### PRIOR ART DOCUMENT

### Patent Document

Patent Document 1: JPH 11-44274 A

### SUMMARY OF THE INVENTION

### Problem to be Solved by the Invention

It is an object of the present invention to provide a fuel injection pump that enables white smoke in exhaust gas to be significantly reduced.

### Solutions to the Problem

A fuel injection pump according to a first aspect of the present invention is configured to deliver, at high pressure, a fuel to be injected into a combustion chamber of a diesel engine, and includes a delivery valve disposed in the middle of a path for pressure-feeding the fuel from a plunger to a fuel injection nozzle and a damping valve disposed on a downstream side of the delivery valve. The damping valve includes a valve element which has an orifice formed on an axial part of the valve element and is biased toward an upstream side by a damping valve spring and a receiving element which has a passage hole formed on an axial part of the receiving element and is configured to abut against the valve element. A recess communicating with the passage hole is formed on a face of the valve element, the face facing the receiving element.

Preferably, in the fuel injection pump according to the first aspect of the present invention, the recess is formed in a cylindrical shape.

A fuel injection pump according to a second aspect of the present invention is configured to deliver, at high pressure, a fuel to be injected into a combustion chamber of a diesel engine, and includes a delivery valve disposed in the middle of a path for pressure-feeding the fuel from a plunger to a fuel injection nozzle and a damping valve disposed on a downstream side of the delivery valve. The damping valve includes a valve element which has an orifice formed on an axial part of the valve element and is biased toward an upstream side by a damping valve spring and a receiving element which has a passage hole formed on an axial part of the receiving element and is configured to abut against the valve element. A recess communicating with the passage hole is formed on a face of the receiving element, the face facing the valve element.

Preferably, in the fuel injection pump according to the second aspect of the present invention, the recess is formed in a cylindrical shape.

### Effects of the Invention

According to the fuel injection pump of the present invention, it is possible to reduce the resistance produced in the second half of fuel injection, reduce the initial injection rate, and thereby significantly reduce white smoke in exhaust gas.

### BRIEF DESCRIPTION OF THE DRAWINGS

FIG. 1 is a side view showing the configuration of a fuel injection pump.

FIG. 2 is a schematic view showing the configuration of a delivery valve according to Embodiment 1.

FIG. 3 is a schematic view showing the configuration of a delivery valve according to Embodiment 2.

FIG. 4 is a schematic view showing the configuration of a delivery valve according to Embodiment 3.

FIGS. 5(A) to 5(C) are schematic views showing the action of the delivery valve according to Embodiment 3.

FIG. 6 is a side view showing the configuration of a fuel injection pump according to Embodiment 4.

FIG. 7 is a side view showing the configuration of a fuel injection pump according to Embodiment 5.

FIG. 8 is a side view showing the configuration of a fuel injection pump according to Embodiment 6.

FIG. 9 is a side view showing the configuration of a fuel injection pump according to Embodiment 7.

### EMBODIMENTS OF THE INVENTION

### Embodiment 1

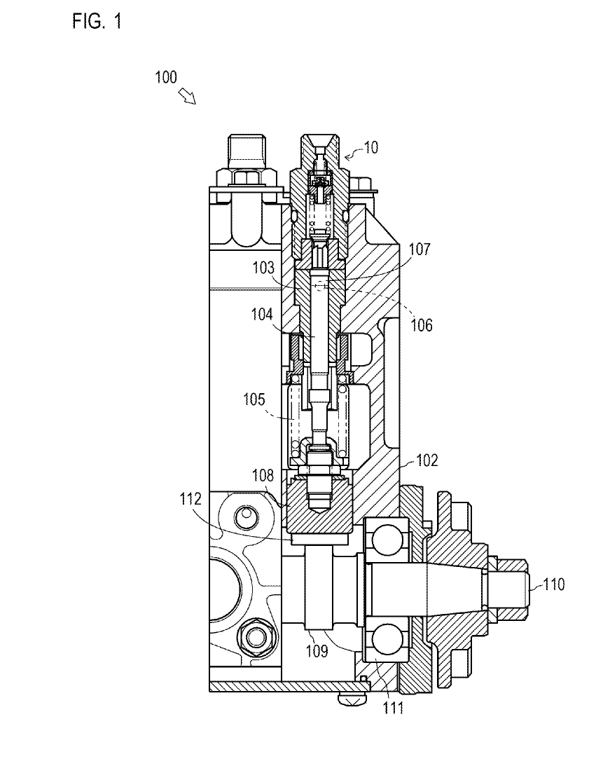

The configuration of a fuel injection pump 100 will be described with reference to FIG. 1.

FIG. 1 illustrates the fuel injection pump 100 in partially sectional view and side view.

The fuel injection pump 100 relates to Embodiment 1 of the fuel injection pump of the present invention. The fuel injection pump 100 is provided in a diesel engine. The fuel injection pump 100 delivers, at high pressure, a fuel to be injected into a combustion chamber of the diesel engine.

The fuel injection pump 100 includes a pump housing 102 which has a hole formed from the upper face toward the lower side thereof and a tubular plunger barrel 103 which is inserted into the hole of the pump housing 102. A plunger 104 is vertically slidably inserted into the plunger barrel 103. A pressure chamber 107 is formed above the plunger 104.

A tappet 108 is inserted under the plunger 104 in such a manner that the tappet 108 can vertically slide inside the pump housing 102 integrally with the plunger 104. A cam 109 abuts against the lower face of the tappet 108 through a roller 112. The plunger 104 and the tappet 108 are biased downward by a plunger spring 105.

The cam 109 is disposed on a cam shaft 110. The cam shaft 110 is rotatably supported on the pump housing 102 of the fuel injection pump 100 through a cam bearing 111. A delivery valve 10 is disposed above the plunger 104. The delivery valve 10 will be described in detail below.

With such a configuration, the tappet 108 which is in sliding contact with the outer periphery of the cam 109 and the plunger 104 vertically slide in a reciprocating manner with the rotation of the cam shaft 110, so that a fuel is pressure-fed by a fuel feed pump (not illustrated). The plunger 104 sliding toward the upstream side (downward) opens a barrel port 106, and the pressure-fed fuel is thereby sucked into the pressure chamber 107. The fuel sucked into the pressure chamber 107 is pressurized when the plunger 104 slides toward the downstream side (upward).

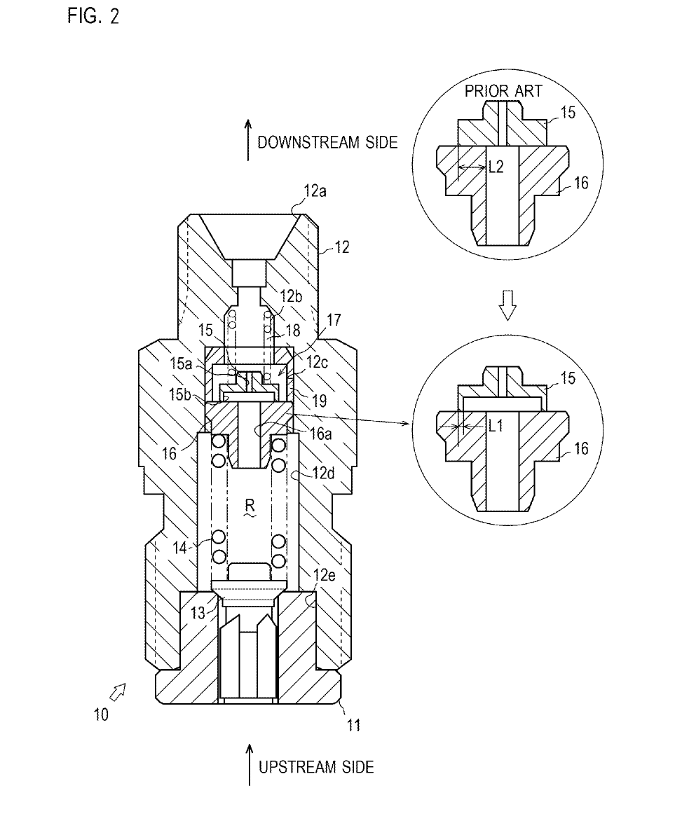

The configuration of the delivery valve 10 will be described with reference to FIG. 2. FIG. 2 illustrates the delivery valve 10 in partially sectional view and side view. On the upper right side of FIG. 2, the configuration of a conventional valve element and a conventional receiving element, and the configuration of a valve element 15 and a receiving element 16 of the present embodiment are enlarged and compared.

The delivery valve 10 is provided with a tubular delivery valve case 11, a delivery valve body 13, and a delivery valve spring 14 which biases the delivery valve body 13 toward the delivery valve case 11.

The delivery valve case 11 and the plunger barrel 103 are inserted into the hole which is formed on the pump housing 102 from the upper face toward the lower side thereof (refer to FIG. 1). The delivery valve body 13 is vertically slidably inserted into the lower part of a spring housing section 12d of a casing 12 and biased toward the delivery valve case 11 (downward) by the delivery valve spring 14. A space formed by the receiving element 16, the spring housing section 12d, and the delivery valve body 13 is referred to as a delivery chamber R.

The casing 12 is a tubular member and inserted from the upper side of the fuel injection pump 100 into the hole which is formed on the pump housing 102 on the upper face thereof. A through hole is formed on an axial part of the casing 12. A fuel discharge port 12a, a small-diameter fuel passage 12b, a guide body housing section 12c, the spring housing section 12d, and a delivery valve case fitting section 12e are formed inside the through hole of the casing 12 in this order from the upper side.

The fuel discharge port 12a is formed in a tapered shape expanding toward the downstream side on a downstream end of the through hole, and a high-pressure tube is connected to the fuel discharge port 12a. The small-diameter fuel passage 12b is formed under (on the upstream side of) the fuel discharge port 12a to receive one side of a damping valve spring 18. The guide body housing section 12c is formed on the upstream side of the small-diameter fuel passage 12b to house a guide body 19 and a damping valve 17.

The damping valve 17 includes the valve element 15 and the receiving element 16.

The damping valve 17 is configured in such a manner that the valve element 15 is biased downward (toward the upstream side) by the damping valve spring 18 so as to abut against the receiving element 16.

The valve element 15 faces the receiving element 16. The valve element 15 is formed in a two-stage cylindrical shape and has an orifice 15a which vertically penetrates an axial part thereof. The valve element 15 has a cylindrical recess 15b which is recessed upward from the center of a face of the valve element 15, the face facing the receiving element 16. The recess 15b communicates with the orifice 15a. The recess 15b is formed in a cylindrical shape. The receiving element 16 is formed in a two-stage cylindrical shape and has a passage hole 16a which vertically penetrates an axial part thereof.

The spring housing section 12d is formed on the upstream side of the guide body housing section 12c to house the delivery valve spring 14 and the upper part of the delivery valve body 13. The delivery valve case fitting section 12e which is fitted with the upper part of the delivery valve case 11 is formed under the spring housing section 12d.

The action of the delivery valve 10 will be described.

When the pressure of the pressurized fuel inside the pressure chamber 107 (refer to FIG. 1) exceeds a predetermined opening pressure for the delivery valve 10 and the damping valve 17, the delivery valve body 13 and the valve element 15 slide toward the downstream side (upward) to open the delivery valve 10 and the damping valve 17. Accordingly, the fuel is pressure-fed to a fuel injection nozzle (not illustrated) through the spring housing section 12d, the passage hole 16a, the small-diameter fuel passage 12b, and the fuel discharge port 12a.

At this time, the resistance of the fuel flowing between the valve element 15 and the receiving element 16 immediately after the lift of the valve element 15 (in the first half of the fuel injection) is similar to that in a conventional configuration due to a small gap between the valve element 15 and the receiving element 16 even when the recess 15b is formed. However, when the lift of the valve element 15 exceeds a predetermined lift amount (in the second half of the fuel injection), the recess 15b sufficiently reduces a distance having the minimum fuel passage width (the minimum gap between the valve element 15 and the receiving element 16) from a conventional distance L2 to a distance L1. Thus, the fuel injection amount is increased.

When this phenomenon is considered based on a fuel injection rate (a fuel injection amount per unit time), the fuel injection rate decreases in the first half of the fuel injection and increases in the second half of the fuel injection. That is, an initial injection rate of the diesel engine is reduced.

An effect of the delivery valve 10 will be described.

The delivery valve 10 makes it possible to reduce the initial injection rate of the fuel injection pump 100 and thereby significantly reduce white smoke in exhaust gas of the diesel engine.

### Embodiment 2

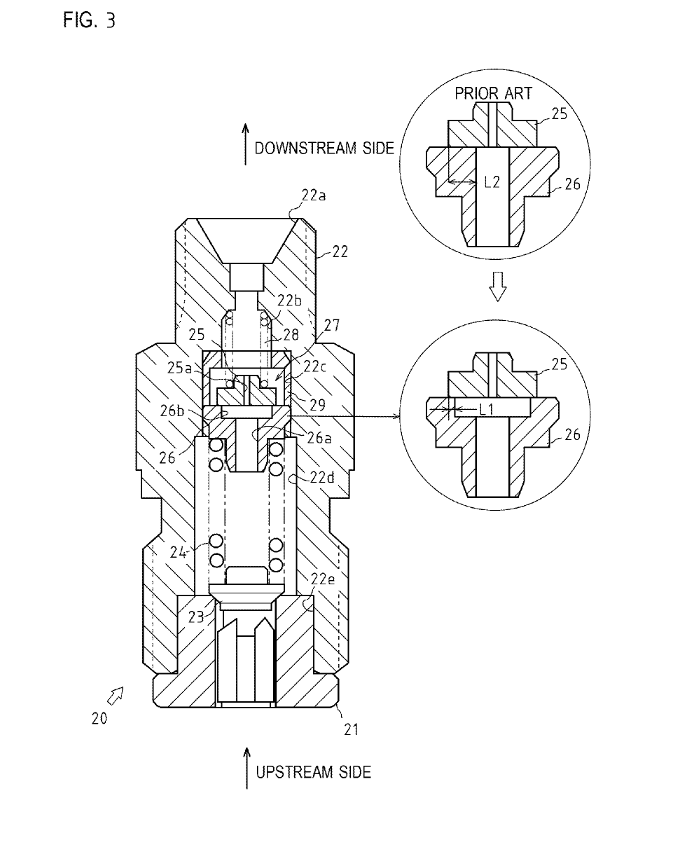

The configuration of a delivery valve 20 will be described with reference to FIG. 3.

FIG. 3 illustrates the delivery valve 20 in partially sectional view and side view. On the upper right side of FIG. 3, the configuration of a conventional valve element and a conventional receiving element, and the configuration of a valve element 25 and a receiving element 26 of the present embodiment are enlarged and compared.

The delivery valve 20 relates to Embodiment 2 of the fuel injection pump of the present invention. A delivery valve case 21, a casing 22, a delivery valve body 23, a delivery valve spring 24, a damping valve spring 28, and a guide body 29 of the delivery valve 20 respectively have configurations similar to the configurations of the delivery valve case 11, the casing 12, the delivery valve body 13, the delivery valve spring 14, the damping valve spring 18, and the guide body 19 of the delivery valve 10. Thus, description thereof will not be provided.

A damping valve 27 includes the valve element 25 and the receiving element 26.

The damping valve 27 is configured in such a manner that the valve element 25 is biased downward (toward the upstream side) by the damping valve spring 28 so as to abut against the receiving element 26.

The valve element 25 is formed in a two-stage cylindrical shape and has an orifice 25a which vertically penetrates an axial part thereof. The receiving element 26 is formed in a two-stage cylindrical shape and has a passage hole 26a which vertically penetrates an axial part thereof. The receiving element 26 has a cylindrical recess 26b which is recessed downward from the center of a face of the receiving element 26, the face facing the valve element 25. The recess 26b communicates with the orifice 25a. The recess 26b is formed in a cylindrical shape.

The action of the delivery valve 20 will be described.

When the pressure of the pressurized fuel inside the pressure chamber 107 exceeds a predetermined opening pressure for the delivery valve 20 and the damping valve 27, the delivery valve body 23 and the valve element 25 slide toward the downstream side (upward) to open the delivery valve 20 and the damping valve 27. Accordingly, the fuel is pressure-fed to a fuel injection nozzle (not illustrated) through a spring housing section 22d, the passage hole 26a, a small-diameter fuel passage 22b, and a fuel discharge port 22a.

At this time, the resistance of the fuel flowing between the valve element 25 and the receiving element 26 immediately after the lift of the valve element 25 (in the first half of the fuel injection) is similar to that in a conventional configuration due to a small gap between the valve element 25 and the receiving element 26 even when the recess 26b is formed. However, when the lift of the valve element 25 exceeds a predetermined lift amount (in the second half of the fuel injection), the recess 26b sufficiently reduces a distance having the minimum fuel passage width (the minimum gap between the valve element 25 and the receiving element 26) from a conventional distance L2 to a distance L1. Thus, the fuel injection amount is increased.

When this phenomenon is considered based on a fuel injection rate (a fuel injection amount per unit time), the fuel injection rate decreases in the first half of the fuel injection, and the fuel injection rate increases in the second half of the fuel injection. That is, an initial injection rate of the diesel engine is reduced.

An effect of the delivery valve 20 will be described.

The delivery valve 20 makes it possible to reduce the initial injection rate of the fuel injection pump 100 and thereby significantly reduce white smoke in exhaust gas of the diesel engine.

### Embodiment 3

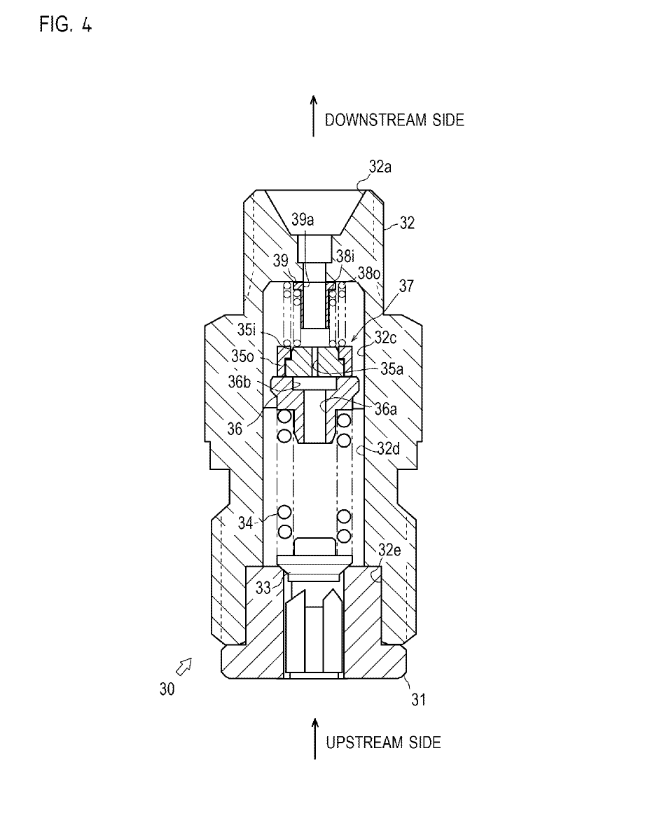

The configuration of a delivery valve 30 will be described with reference to FIG. 4.

FIG. 4 illustrates the delivery valve 30 in partially sectional view and side view.

The delivery valve 30 relates to Embodiment 3 of the fuel injection pump of the present invention. A delivery valve case 31, a casing 32, a delivery valve body 33, and a delivery valve spring 34 of the delivery valve 30 respectively have configurations similar to the configurations of the delivery valve case 11, the casing 12, the delivery valve body 13, and the delivery valve spring 14 of the delivery valve 10. Thus, description thereof will not be provided.

A damping valve 37 includes an inner valve element 35i, an outer valve element 35o, a receiving element 36, and a support 39. The inner valve element 35i is biased downward (toward the upstream side) from the support 39 by an inner damping valve spring 38i so as to abut against the receiving element 36. The outer valve element 35o is biased downward (toward the upstream side) from the casing 32 by an outer damping valve spring 38o so as to abut against the receiving element 36.

The inner valve element 35i is formed in a two-stage cylindrical shape and has an orifice 35a which vertically penetrates an axial part thereof. The outer valve element 35o is formed in an annular shape. The receiving element 36 is formed in a two-stage cylindrical shape and has a passage hole 36a which vertically penetrates an axial part thereof. The support 39 is formed in a two-stage cylindrical shape and has a passage hole 39a which vertically penetrates an axial part thereof.

The outer valve element 35o is engaged with a stepped part of the inner valve element 35i. That is, a biasing force of the outer damping valve spring 38o and a biasing force of the inner damping valve spring 38i are applied to the inner valve element 35i.

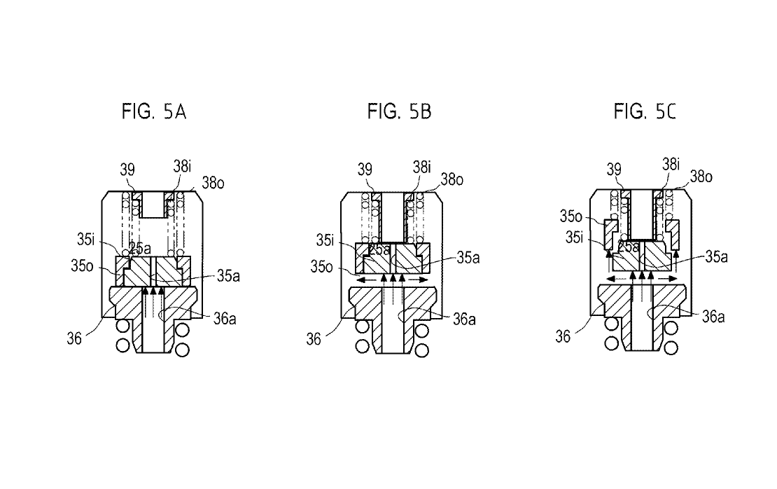

The action of the delivery valve 30 will be described with reference to FIGS. 5(A) to 5(C).

FIGS. 5(A) to 5(C) illustrate the delivery valve 30 in partially sectional view and side view.

As shown in FIG. 5(A), when the pressure of the pressurized fuel inside the pressure chamber 107 exceeds a predetermined opening pressure for the damping valve 37, the fuel pressure-fed through the passage hole 36a of the receiving element 36 overcomes the biasing forces of the inner damping valve spring 38i and the outer damping valve spring 38o, so that the inner valve element 35i and the outer valve element 35o are lifted toward the downstream side (upward) (in the first half of the fuel injection). At this time, the inner valve element 35i and the outer valve element 35o receive resistance produced by the biasing forces of the inner damping valve spring 38i and the outer damping valve spring 38o.

As shown in FIG. 5(B), when the inner valve element 35i and the outer valve element 35o are further lifted toward the downstream side (upward), the upper end face of the inner valve element 35i comes into contact with the lower end face of the support 39.

As shown in FIG. 5(C), when the upper end face of the inner valve element 35i comes into contact with the lower end face of the support 39, the outer valve element 35o is separated from the inner valve element 35i and lifted toward the downstream side (upward) (in the second half of the fuel injection). At this point, since the outer valve element 35o receives resistance produced only by the biasing force of the outer damping valve spring 38o, the lift amount increases. Thus, the fuel injection amount becomes larger than that in the first half of the fuel injection.

When this phenomenon is considered based on a fuel injection rate (a fuel injection amount per unit time), the fuel injection rate decreases in the first half of the fuel injection, and the fuel injection rate increases in the second half of the fuel injection. That is, an initial injection rate of the diesel engine is reduced.

An effect of the delivery valve 30 will be described.

The delivery valve 30 makes it possible to reduce the initial injection rate of the fuel injection pump 100 and thereby significantly reduce white smoke in exhaust gas of the diesel engine.

### Embodiment 4

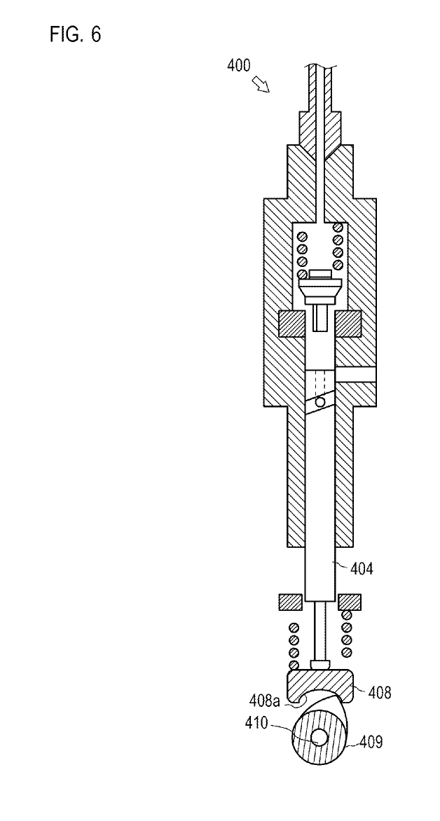

The configuration of a fuel injection pump 400 will be described with reference to FIG. 6.

FIG. 6 schematically illustrates the fuel injection pump 400.

The fuel injection pump 400 relates to Embodiment 4 of the fuel injection pump of the present invention. The fuel injection pump 400 is similar to the fuel injection pump 100 according to Embodiment 1 except for a part particularly described below.

A recess 408a is formed on the lower face of a tappet 408. There is not a roller between the recess 408a and the lower face of a tappet 408. The recess 408a is formed in a circular arc shape when viewed from a direction perpendicular to a cam shaft 410. The recess 408a varies a contact position between a cam 409 and the recess 408a depending on the shape of the cam 409. Thus, the timing and amount of vertical reciprocating slide of a plunger 404 caused by the cam 409 are varied. That is, the fuel injection amount can be varied without changing the profile of the cam 409. The recess 408a is formed so that the fuel injection amount increases in the second half of fuel injection.

Such a configuration enables an initial injection rate of the diesel engine to be reduced. That is, it is possible to reduce the initial injection rate of the fuel injection pump 400 and thereby significantly reduce white smoke in exhaust gas of the diesel engine.

### Embodiment 5

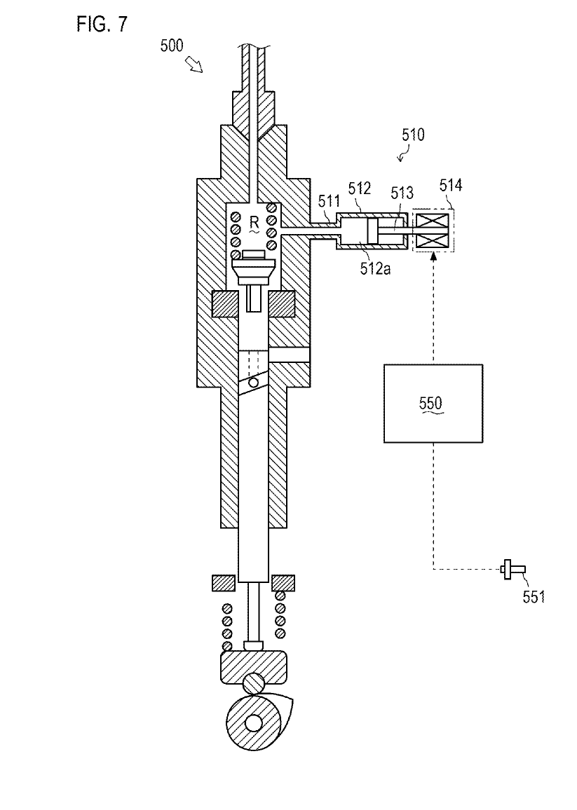

The configuration of a fuel injection pump 500 will be described with reference to FIG. 7.

FIG. 7 illustrates the fuel injection pump 500 in partially sectional view and side view.

The fuel injection pump 500 relates to Embodiment 5 of the fuel injection pump of the present invention. The fuel injection pump 500 is similar to the fuel injection pump 100 according to Embodiment 1 except for a part particularly described below.

A capacity addition mechanism 510 communicates with a delivery chamber R. The capacity of the capacity addition mechanism 510 decreases as the engine speed increases and increases as the engine speed decreases. The capacity addition mechanism 510 is provided with a passage 511, a cylinder chamber 512, a fuel chamber 512a, a piston 513, a solenoid 514, and a controller 550.

The cylinder chamber 512 forms the fuel chamber 512a by the piston 513. The passage 511 allows the delivery chamber R formed on a casing and the fuel chamber 512a to communicate with each other. The piston 513 slides inside the cylinder chamber 512 to increase or reduce the capacity of the fuel chamber 512a. The solenoid 514 is connected to the controller 550 to drive the piston 513 to reciprocate.

The controller 550 is connected to the solenoid 514 and an engine speed senor 551 which detects the engine speed of an engine (not illustrated) provided with the fuel injection pump 500. The controller 550 has a function of controlling the solenoid 514 to drive the piston 513 so as to reduce the capacity of the cylinder chamber 512 as the engine speed increases and controlling the solenoid 514 to drive the piston 513 so as to increase the capacity of the cylinder chamber 512 as the engine speed decreases.

The action of the capacity addition mechanism 510 will be described. With the capacity addition mechanism 510, the capacity of the cylinder chamber 512 of the capacity addition mechanism 510 is added to the capacity of the conventional delivery chamber R. Thus, a time lag occurs when the injection pressure is transmitted to a fuel injection nozzle (not illustrated) to delay a fuel injection timing. That is, providing the capacity addition mechanism 510 delays the fuel injection timing over the entire engine speed (first control).

On the other hand, in the capacity addition mechanism 510, the capacity of the cylinder chamber 512 is reduced as the engine speed increases. Thus, although the fuel injection timing is delayed over the entire engine speed by the first control, the time lag is eliminated before the injection pressure is transmitted to the fuel injection nozzle (not illustrated) to advance the fuel injection timing. That is, the fuel injection timing is advanced compared to that during the first control only when the engine speed is high (second control).

An effect of the capacity addition mechanism 510 will be described.

The capacity addition mechanism 510 enables the generation of Sd and deterioration in a white smoke disappearance time to be improved. That is, since the fuel injection timing is delayed over the entire engine speed by the first control and advanced by the second control only when the engine speed is high, the generation of Sd and the deterioration in the white smoke disappearance time can be improved.

### Embodiment 6

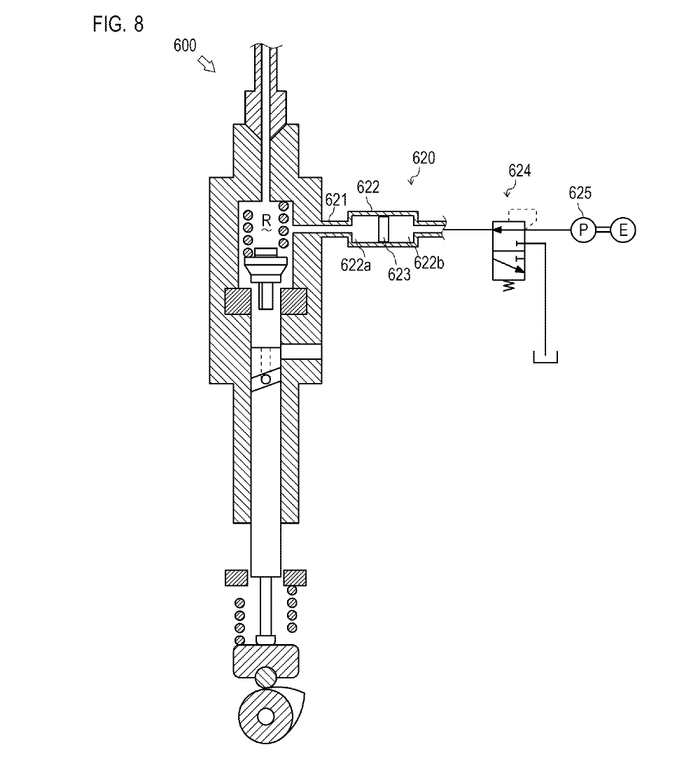

The configuration of a fuel injection pump 600 will be described with reference to FIG. 8.

FIG. 8 illustrates the fuel injection pump 600 in partially sectional view and side view.

The fuel injection pump 600 relates to Embodiment 6 of the fuel injection pump of the present invention. The fuel injection pump 600 is similar to the fuel injection pump 100 according to Embodiment 1 except for a part particularly described below.

A capacity addition mechanism 620 communicates with a delivery chamber R. The capacity of the capacity addition mechanism 620 decreases as the engine speed increases and increases as the engine speed decreases. The capacity addition mechanism 620 is provided with a passage 621, a cylinder chamber 622, a piston 623, a switching valve 624, and a hydraulic pump 625.

The passage 621, the cylinder chamber 622, a fuel chamber 622a, and the piston 623 respectively have configurations similar to the configurations of the passage 511, the cylinder chamber 512, and the piston 513 of Embodiment 5. Thus, description thereof will not be provided.

The cylinder chamber 622 is divided into the fuel chamber 622a and an operating oil chamber 622b by the piston 623. The switching valve 624 is disposed between the hydraulic pump 625 and the cylinder chamber 622. The switching valve 624 has a function of supplying an operating oil to the operating oil chamber 622b of the cylinder chamber 622 when the pressure of the operating oil fed from the hydraulic pump 625 becomes a predetermined pressure or more. The hydraulic pump 625 is driven by an engine provided with the fuel injection pump 600.

The action of the capacity addition mechanism 620 will be described. With the capacity addition mechanism 620, the capacity of the cylinder chamber 622 of the capacity addition mechanism 620 is added to the capacity of the conventional delivery chamber R. Thus, a time lag occurs when the injection pressure is transmitted to a fuel injection nozzle (not illustrated) to delay a fuel injection timing. That is, providing the capacity addition mechanism 620 delays the fuel injection timing over the entire engine speed (first control).

On the other hand, in the capacity addition mechanism 620, when the operating pressure by the hydraulic pump 625 increases to a predetermined pressure or more as the engine speed increases, the switching valve 624 is switched to supply the operating oil to the operating oil chamber 62b. Accordingly, the piston 623 inside the cylinder chamber 622 moves toward the fuel chamber 622a to reduce the capacity of the fuel chamber 622a. Thus, although the fuel injection timing is delayed over the entire engine speed by the first control, the time lag is eliminated before the injection pressure is transmitted to the fuel injection nozzle (not illustrated) to advance the fuel injection timing. That is, the fuel injection timing is advanced compared to that during the first control only when the engine speed is high (second control).

An effect of the capacity addition mechanism 620 will be described. The capacity addition mechanism 620 enables the generation of Sd and deterioration in a white smoke disappearance time to be improved. That is, since the fuel injection timing is delayed over the entire engine speed by the first control and advanced by the second control only when the engine speed is high, the generation of Sd and the deterioration in the white smoke disappearance time can be improved.

### Embodiment 7

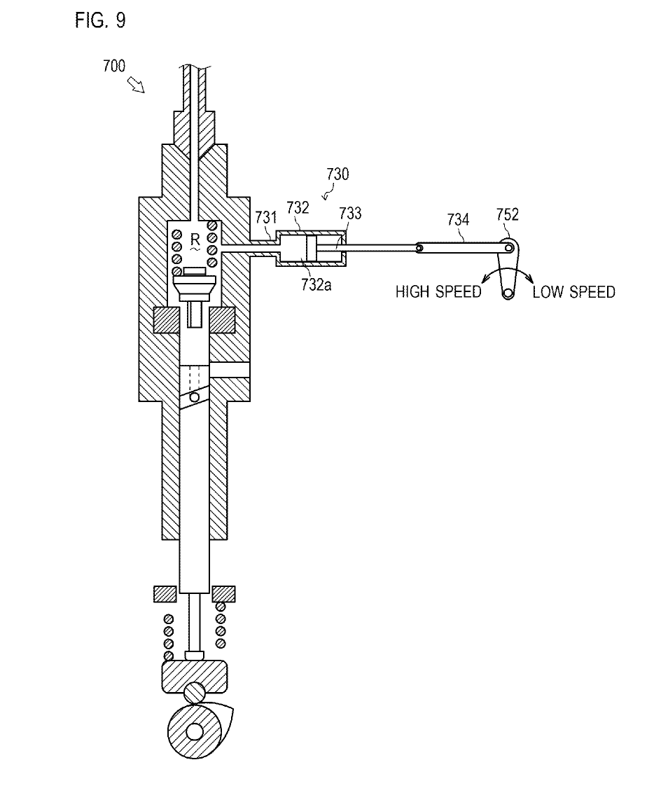

The configuration of a fuel injection pump 700 will be described with reference to FIG. 9.

FIG. 9 illustrates the fuel injection pump 700 in partially sectional view and side view.

The fuel injection pump 700 relates to Embodiment 7 of the fuel injection pump of the present invention. The fuel injection pump 700 is similar to the fuel injection pump 100 according to Embodiment 1 except for a part particularly described below.

A capacity addition mechanism 730 communicates with a delivery chamber R. The capacity of the capacity addition mechanism 730 decreases as the engine speed increases and increases as the engine speed decreases. The capacity addition mechanism 730 is provided with a passage 731, a cylinder chamber 732, a piston 733, and a synchronous link 734.

The passage 731, the cylinder chamber 732, a combustion chamber 732a, and the piston 733 respectively have configurations similar to the configurations of the passage 511, the cylinder chamber 512, the combustion chamber 512a, and the piston 513 of Embodiment 5. Thus, description thereof will not be provided.

A regulator lever 752 is disposed on an engine provided with the fuel injection pump 700. The regulator lever 752 is operated to turn to adjust the fuel injection amount of the fuel injection pump 100 to control the engine speed.

One end of the synchronous link 734 is turnably supported on the other end side of the piston 733, and the other end of the synchronous link 734 is turnably supported on one end side of the regulator lever 752. The synchronous link 734 supports the piston 733 and the regulator valve 752 so as to reduce the capacity of the cylinder chamber 732 when the regulator lever 752 is turned to control the engine speed at a high speed and increase the capacity of the cylinder chamber 732 when the regulator lever 752 is turned to control the engine speed at a low speed.

The action of the capacity addition mechanism 730 will be described.

With the capacity addition mechanism 730, the capacity of the cylinder chamber 732 of the capacity addition mechanism 730 is added to the capacity of the conventional delivery chamber R. Thus, a time lag occurs when the injection pressure is transmitted to a fuel injection nozzle (not illustrated) to delay a fuel injection timing. That is, providing the capacity addition mechanism 720 delays the fuel injection timing over the entire engine speed (first control).

On the other hand, in the capacity addition mechanism 730, the capacity of the cylinder chamber 732 is reduced by turning the regulator lever 752 so as to increase the engine speed. Thus, although the fuel injection timing is delayed over the entire engine speed by the first control, the time lag is eliminated before the injection pressure is transmitted to the fuel injection nozzle (not illustrated) to advance the fuel injection timing. That is, the fuel injection timing is advanced compared to that during the first control only when the engine speed is high (second control).

An effect of the capacity addition mechanism 730 will be described.

The capacity addition mechanism 730 enables the generation of Sd and deterioration in a white smoke disappearance time to be improved. That is, since the fuel injection timing is delayed over the entire engine speed by the first control and advanced by the second control only when the engine speed is high, the generation of Sd and the deterioration in the white smoke disappearance time can be improved.

### INDUSTRIAL APPLICABILITY

The present invention is applicable to a fuel injection pump.

### DESCRIPTION OF REFERENCE SIGNS

10: Delivery valve
15: Valve element
15a: Orifice
15b: Recess
16: Receiving element
16a: Passage hole
17: Damping valve
100: Fuel injection pump

1. A fuel injection pump configured to deliver, at high pressure, a fuel to be injected into a combustion chamber of a diesel engine, the fuel injection pump comprising:
a delivery valve disposed in the middle of a path for pressure-feeding the fuel from a plunger to a fuel injection nozzle; and
a damping valve disposed on a downstream side of the delivery valve, the damping valve comprising
a valve element having an orifice formed on an axial part of the valve element, the valve element being biased toward an upstream side by a damping valve spring, and
a receiving element having a passage hole formed on an axial part of the receiving element, the receiving element being configured to abut against the valve element,
wherein a recess communicating with the passage hole is formed on a face of the valve element, the face facing the receiving element.

2. The fuel injection pump according to claim 1, wherein the recess is formed in a cylindrical shape.

3. A fuel injection pump configured to deliver, at high pressure, a fuel to be injected into a combustion chamber of a diesel engine, the fuel injection pump comprising:
a delivery valve disposed in the middle of a path for pressure-feeding the fuel from a plunger to a fuel injection nozzle; and
a damping valve disposed on a downstream side of the delivery valve, the damping valve comprising
a valve element having an orifice formed on an axial part of the valve element, the valve element being biased toward an upstream side by a damping valve spring, and
a receiving element having a passage hole formed on an axial part of the receiving element, the receiving element being configured to abut against the valve element,
wherein a recess communicating with the passage hole is formed on a face of the receiving element, the face facing the valve element.

4. The fuel injection pump according to claim 3, wherein the recess is formed in a cylindrical shape.
